(19) United States
(12) Patent Application Publication
(10) Pub. No.: US 2024/0256580 A1
(43) Pub. Date: Aug. 1, 2024

(54) INTEGRATED INDEX PLATFORM SUPPORTING SUBINDEXES

(71) Applicant: Walmart Apollo, LLC, Bentonville, AR (US)

(72) Inventors: Menkae Jeng, San Jose, CA (US); Shiqi Jia, San Jose, CA (US); Archit Agarwal, Mainpuri (IN); Rahul Gupta, Fremont, CA (US)

(73) Assignee: Walmart Apollo, LLC, Bentonville, AR (US)

(21) Appl. No.: 18/103,113

(22) Filed: Jan. 30, 2023

(51) Int. Cl. G06F 16/31

(52) U.S. Cl. CPC G06F 16/328

(57) ABSTRACT

A method including obtaining an index message at both (a) an index updater for an index and (b) a subindex updater for a subindex. The method also can include updating, by the index updater, the index based on the index message. The method additionally can include determining, at the subindex updater, whether the index message is eligible for the subindex. The method further can include updating, by the subindex updater, the subindex based on the index message when the index message is eligible for the subindex. Other embodiments are described.

### TECHNICAL FIELD

This disclosure relates generally to an integrated index platform supporting subindexes.

### BACKGROUND

Indexing platforms are commonly used in large search systems to find relevant documents for a search query. Search indexing generally involves indexing documents to facilitate searching those documents using a search index. Generating a search index can take hours to complete, and some of the underlying documents can change during that process. The search index can be updated when changes are made to the documents.

### BRIEF DESCRIPTION OF THE DRAWINGS

To facilitate further description of the embodiments, the following drawings are provided in which:

FIG. 1 illustrates a front elevational view of a computer system that is suitable for implementing an embodiment of the system disclosed in FIG. 3;

FIG. 2 illustrates a representative block diagram of an example of the elements included in the circuit boards inside a chassis of the computer system of FIG. 1;

FIG. 3 illustrates a block diagram of a system that can be employed for an integrated index platform supporting subindexes, according to an embodiment;

FIG. 4 illustrates a block diagram of the integrated indexing system of FIG. 3 that implements an integrated index platform supporting two search subindexes, and illustrates a message flow within that platform; and

FIG. 5 illustrates a flow chart for a method of providing an integrated index platform supporting subindexes, according to another embodiment.

For simplicity and clarity of illustration, the drawing figures illustrate the general manner of construction, and descriptions and details of well-known features and techniques may be omitted to avoid unnecessarily obscuring the present disclosure. Additionally, elements in the drawing figures are not necessarily drawn to scale. For example, the dimensions of some of the elements in the figures may be exaggerated relative to other elements to help improve understanding of embodiments of the present disclosure. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the apparatus, methods, and/or articles of manufacture described herein are, for example, capable of operation in other orientations than those illustrated or otherwise described herein.

The terms “couple,” “coupled,” “couples,” “coupling,” and the like should be broadly understood and refer to connecting two or more elements mechanically and/or otherwise. Two or more electrical elements may be electrically coupled together, but not be mechanically or otherwise coupled together. Coupling may be for any length of time, e.g., permanent or semi-permanent or only for an instant. “Electrical coupling” and the like should be broadly understood and include electrical coupling of all types. The absence of the word “removably,” “removable,” and the like near the word “coupled,” and the like does not mean that the coupling, etc. in question is or is not removable.

As defined herein, two or more elements are “integral” if they are comprised of the same piece of material. As defined herein, two or more elements are “non-integral” if each is comprised of a different piece of material.

As defined herein, “approximately” can, in some embodiments, mean within plus or minus ten percent of the stated value. In other embodiments, “approximately” can mean within plus or minus five percent of the stated value. In further embodiments, “approximately” can mean within plus or minus three percent of the stated value. In yet other embodiments, “approximately” can mean within plus or minus one percent of the stated value.

As defined herein, “real-time” can, in some embodiments, be defined with respect to operations carried out as soon as practically possible upon occurrence of a triggering event. A triggering event can include receipt of data necessary to execute a task or to otherwise process information. Because of delays inherent in transmission and/or in computing speeds, the term “real-time” encompasses operations that occur in “near” real-time or somewhat delayed from a triggering event. In a number of embodiments, “real-time” can mean real-time less a time delay for processing (e.g., determining) and/or transmitting data. The particular time delay can vary depending on the type and/or amount of the data, the processing speeds of the hardware, the transmission capability of the communication hardware, the transmission distance, etc. However, in many embodiments, the time delay can be less than approximately 1 second, 5 seconds, 10 seconds, 1 minute, 5 minutes, 10 minutes, or 30 minutes.

### DESCRIPTION OF EXAMPLES OF EMBODIMENTS

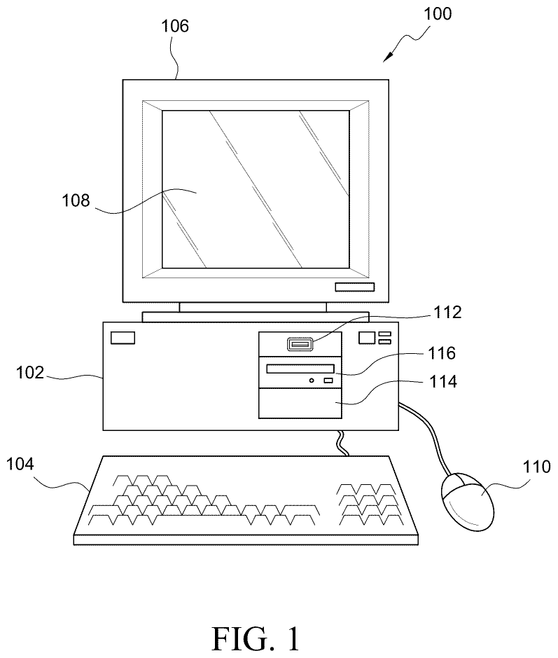

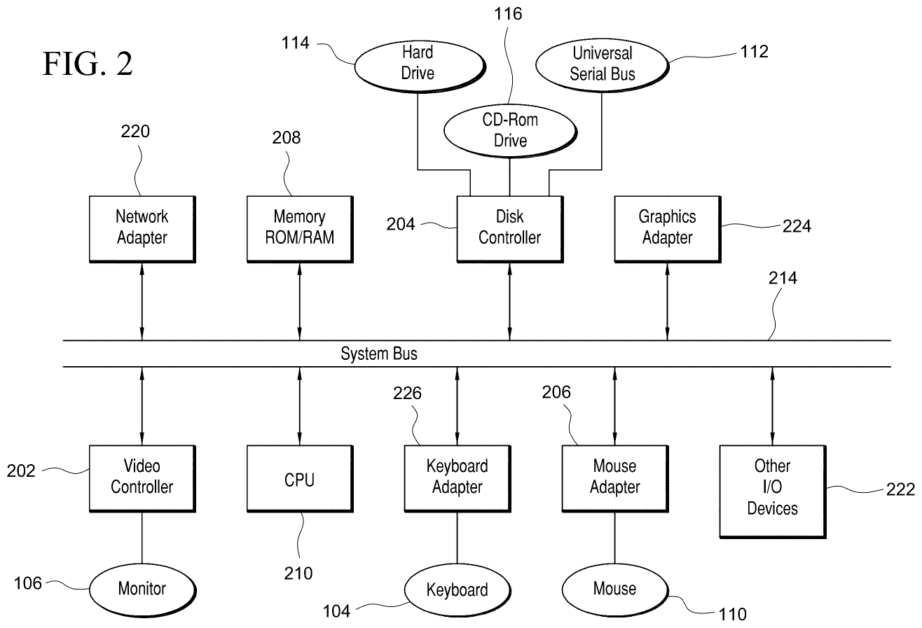

Turning to the drawings, FIG. 1 illustrates an exemplary embodiment of a computer system 100, all of which or a portion of which can be suitable for (i) implementing part or all of one or more embodiments of the techniques, methods, and systems and/or (ii) implementing and/or operating part or all of one or more embodiments of the non-transitory computer readable media described herein. As an example, a different or separate one of computer system 100 (and its internal components, or one or more elements of computer system 100) can be suitable for implementing part or all of the techniques described herein. Computer system 100 can comprise chassis 102 containing one or more circuit boards (not shown), a Universal Serial Bus (USB) port 112, a Compact Disc Read-Only Memory (CD-ROM) and/or Digital Video Disc (DVD) drive 116, and a hard drive 114. A representative block diagram of the elements included on the circuit boards inside chassis 102 is shown in FIG. 2. A central processing unit (CPU) 210 in FIG. 2 is coupled to a system bus 214 in FIG. 2. In various embodiments, the architecture of CPU 210 can be compliant with any of a variety of commercially distributed architecture families.

Continuing with FIG. 2, system bus 214 also is coupled to memory storage unit 208 that includes both read only memory (ROM) and random access memory (RAM). Non-volatile portions of memory storage unit 208 or the ROM can be encoded with a boot code sequence suitable for restoring computer system 100 (FIG. 1) to a functional state after a system reset. In addition, memory storage unit 208 can include microcode such as a Basic Input-Output System (BIOS). In some examples, the one or more memory storage units of the various embodiments disclosed herein can include memory storage unit 208, a USB-equipped electronic device (e.g., an external memory storage unit (not shown) coupled to universal serial bus (USB) port 112 (FIGS. 1-2)), hard drive 114 (FIGS. 1-2), and/or CD-ROM, DVD, Blu-Ray, or other suitable media, such as media configured to be used in CD-ROM and/or DVD drive 116 (FIGS. 1-2). Non-volatile or non-transitory memory storage unit(s) refer to the portions of the memory storage units(s) that are non-volatile memory and not a transitory signal. In the same or different examples, the one or more memory storage units of the various embodiments disclosed herein can include an operating system, which can be a software program that manages the hardware and software resources of a computer and/or a computer network. The operating system can perform basic tasks such as, for example, controlling and allocating memory, prioritizing the processing of instructions, controlling input and output devices, facilitating networking, and managing files. Exemplary operating systems can include one or more of the following: (i) Microsoft® Windows® operating system (OS) by Microsoft Corp. of Redmond, Washington, United States of America, (ii) Mac® OS X by Apple Inc. of Cupertino, California, United States of America, (iii) UNIX® OS, and (iv) Linux® OS. Further exemplary operating systems can comprise one of the following: (i) the iOS® operating system by Apple Inc. of Cupertino, California, United States of America, (ii) the WebOS operating system by LG Electronics of Seoul, South Korea, (iii) the Android™ operating system developed by Google, of Mountain View, California, United States of America, or (iv) the Windows Mobile™ operating system by Microsoft Corp. of Redmond, Washington, United States of America.

As used herein, “processor” and/or “processing module” means any type of computational circuit, such as but not limited to a microprocessor, a microcontroller, a controller, a complex instruction set computing (CISC) microprocessor, a reduced instruction set computing (RISC) microprocessor, a very long instruction word (VLIW) microprocessor, a graphics processor, a digital signal processor, or any other type of processor or processing circuit capable of performing the desired functions. In some examples, the one or more processors of the various embodiments disclosed herein can comprise CPU 210.

In the depicted embodiment of FIG. 2, various I/O devices such as a disk controller 204, a graphics adapter 224, a video controller 202, a keyboard adapter 226, a mouse adapter 206, a network adapter 220, and other I/O devices 222 can be coupled to system bus 214. Keyboard adapter 226 and mouse adapter 206 are coupled to a keyboard 104 (FIGS. 1-2) and a mouse 110 (FIGS. 1-2), respectively, of computer system 100 (FIG. 1). While graphics adapter 224 and video controller 202 are indicated as distinct units in FIG. 2, video controller 202 can be integrated into graphics adapter 224, or vice versa in other embodiments. Video controller 202 is suitable for refreshing a monitor 106 (FIGS. 1-2) to display images on a screen 108 (FIG. 1) of computer system 100 (FIG. 1). Disk controller 204 can control hard drive 114 (FIGS. 1-2), USB port 112 (FIGS. 1-2), and CD-ROM and/or DVD drive 116 (FIGS. 1-2). In other embodiments, distinct units can be used to control each of these devices separately.

In some embodiments, network adapter 220 can comprise and/or be implemented as a WNIC (wireless network interface controller) card (not shown) plugged or coupled to an expansion port (not shown) in computer system 100 (FIG. 1). In other embodiments, the WNIC card can be a wireless network card built into computer system 100 (FIG. 1). A wireless network adapter can be built into computer system 100 (FIG. 1) by having wireless communication capabilities integrated into the motherboard chipset (not shown), or implemented via one or more dedicated wireless communication chips (not shown), connected through a PCI (peripheral component interconnector) or a PCI express bus of computer system 100 (FIG. 1) or USB port 112 (FIG. 1). In other embodiments, network adapter 220 can comprise and/or be implemented as a wired network interface controller card (not shown).

Although many other components of computer system 100 (FIG. 1) are not shown, such components and their interconnection are well known to those of ordinary skill in the art. Accordingly, further details concerning the construction and composition of computer system 100 (FIG. 1) and the circuit boards inside chassis 102 (FIG. 1) are not discussed herein.

When computer system 100 in FIG. 1 is running, program instructions stored on a USB drive in USB port 112, on a CD-ROM or DVD in CD-ROM and/or DVD drive 116, on hard drive 114, or in memory storage unit 208 (FIG. 2) are executed by CPU 210 (FIG. 2). A portion of the program instructions, stored on these devices, can be suitable for carrying out all or at least part of the techniques described herein. In various embodiments, computer system 100 can be reprogrammed with one or more modules, system, applications, and/or databases, such as those described herein, to convert a general purpose computer to a special purpose computer. For purposes of illustration, programs and other executable program components are shown herein as discrete systems, although it is understood that such programs and components may reside at various times in different storage components of computing device 100, and can be executed by CPU 210. Alternatively, or in addition to, the systems and procedures described herein can be implemented in hardware, or a combination of hardware, software, and/or firmware. For example, one or more application specific integrated circuits (ASICs) can be programmed to carry out one or more of the systems and procedures described herein. For example, one or more of the programs and/or executable program components described herein can be implemented in one or more ASICs.

Although computer system 100 is illustrated as a desktop computer in FIG. 1, there can be examples where computer system 100 may take a different form factor while still having functional elements similar to those described for computer system 100. In some embodiments, computer system 100 may comprise a single computer, a single server, or a cluster or collection of computers or servers, or a cloud of computers or servers. Typically, a cluster or collection of servers can be used when the demand on computer system 100 exceeds the reasonable capability of a single server or computer. In certain embodiments, computer system 100 may comprise a portable computer, such as a laptop computer. In certain other embodiments, computer system 100 may comprise a mobile device, such as a smartphone. In certain additional embodiments, computer system 100 may comprise an embedded system.

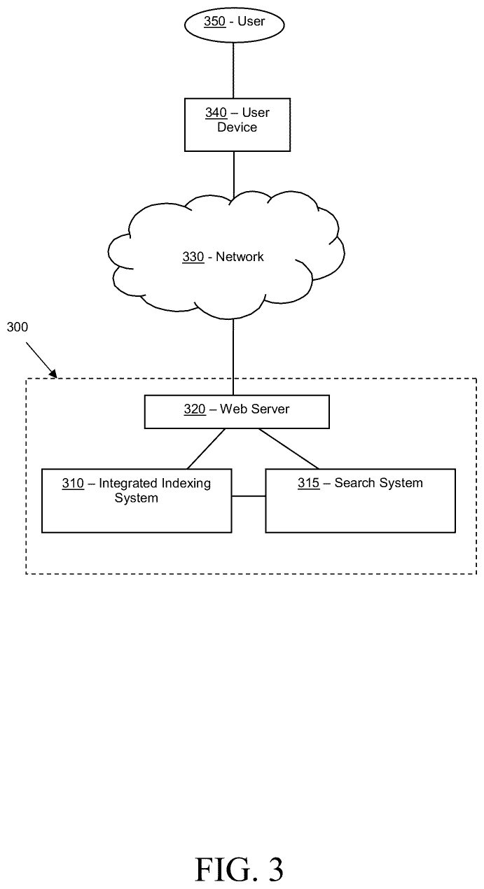

Turning ahead in the drawings, FIG. 3 illustrates a block diagram of a system 300 that can be employed for an integrated index platform supporting subindexes, according to an embodiment. System 300 is merely exemplary and embodiments of the system are not limited to the embodiments presented herein. The system can be employed in many different embodiments or examples not specifically depicted or described herein. In some embodiments, certain elements, modules, or systems of system 300 can perform various procedures, processes, and/or activities. In other embodiments, the procedures, processes, and/or activities can be performed by other suitable elements, modules, or systems of system 300. In some embodiments, system 300 can include an integrated indexing system 310, a search system 315, and/or a web server 320.

Generally, therefore, system 300 can be implemented with hardware and/or software, as described herein. In some embodiments, part or all of the hardware and/or software can be conventional, while in these or other embodiments, part or all of the hardware and/or software can be customized (e.g., optimized) for implementing part or all of the functionality of system 300 described herein.

Integrated indexing system 310, search system 315, and/or web server 320 can each be a computer system, such as computer system 100 (FIG. 1), as described above, and can each be a single computer, a single server, or a cluster or collection of computers or servers, or a cloud of computers or servers. In another embodiment, a single computer system can host two or all of integrated indexing system 310, search system 315, and/or web server 320. Additional details regarding integrated indexing system 310, search system 315, and/or web server 320 are described herein.

In some embodiments, web server 320 can be in data communication through a network 330 with one or more user devices, such as a user device 340. User device 340 can be part of system 300 or external to system 300. Network 330 can be the Internet or another suitable network. In some embodiments, user device 340 can be used by users, such as a user 350. In many embodiments, web server 320 can host one or more websites and/or mobile application servers. For example, web server 320 can host a website, or provide a server that interfaces with an application (e.g., a mobile application), on user device 340, which can allow users (e.g., 350) to browse and/or search for items (e.g., products, grocery items), to add items to an electronic cart, and/or to purchase items, in addition to other suitable activities, or to interface with and/or configure integrated indexing system 310. For example, the user may use a search query to search for a particular item, and one or more of the indexes and/or subindexes generated by integrated indexing system 310 can be used by search system 315 to provide search results responsive to that search query. Search system 315 can be a conventional search engine, such as a search engine provided by Solr or Elasticsearch.

In some embodiments, an internal network that is not open to the public can be used for communications between integrated indexing system 310 and web server 320 within system 300. Accordingly, in some embodiments, integrated indexing system 310 and search system 315 (and/or the software used by such systems) can refer to a back end of system 300 operated by an operator and/or administrator of system 300, and web server 320 (and/or the software used by such systems) can refer to a front end of system 300, as is can be accessed and/or used by one or more users, such as user 350, using user device 340. In these or other embodiments, the operator and/or administrator of system 300 can manage system 300, the processor(s) of system 300, and/or the memory storage unit(s) of system 300 using the input device(s) and/or display device(s) of system 300.

In certain embodiments, the user devices (e.g., user device 340) can be desktop computers, laptop computers, mobile devices, and/or other endpoint devices used by one or more users (e.g., user 350). A mobile device can refer to a portable electronic device (e.g., an electronic device easily conveyable by hand by a person of average size) with the capability to present audio and/or visual data (e.g., text, images, videos, music, etc.). For example, a mobile device can include at least one of a digital media player, a cellular telephone (e.g., a smartphone), a personal digital assistant, a handheld digital computer device (e.g., a tablet personal computer device), a laptop computer device (e.g., a notebook computer device, a netbook computer device), a wearable user computer device, or another portable computer device with the capability to present audio and/or visual data (e.g., images, videos, music, etc.). Thus, in many examples, a mobile device can include a volume and/or weight sufficiently small as to permit the mobile device to be easily conveyable by hand. For examples, in some embodiments, a mobile device can occupy a volume of less than or equal to approximately 1790 cubic centimeters, 2434 cubic centimeters, 2876 cubic centimeters, 4056 cubic centimeters, and/or 5752 cubic centimeters. Further, in these embodiments, a mobile device can weigh less than or equal to 15.6 Newtons, 17.8 Newtons, 22.3 Newtons, 31.2 Newtons, and/or 44.5 Newtons.

Exemplary mobile devices can include (i) an iPod®, iPhone®, iTouch®, iPad®, MacBook® or similar product by Apple Inc. of Cupertino, California, United States of America, (ii) a Lumia® or similar product by the Nokia Corporation of Keilaniemi, Espoo, Finland, and/or (iii) a Galaxy™ or similar product by the Samsung Group of Samsung Town, Seoul, South Korea. Further, in the same or different embodiments, a mobile device can include an electronic device configured to implement one or more of (i) the iPhone® operating system by Apple Inc. of Cupertino, California, United States of America, (ii) the Android™ operating system developed by the Open Handset Alliance, or (iii) the Windows Mobile™ operating system by Microsoft Corp. of Redmond, Washington, United States of America.

In many embodiments, integrated indexing system 310, search system 315, and/or web server 320 can each include one or more input devices (e.g., one or more keyboards, one or more keypads, one or more pointing devices such as a computer mouse or computer mice, one or more touchscreen displays, a microphone, etc.), and/or can each comprise one or more display devices (e.g., one or more monitors, one or more touch screen displays, projectors, etc.). In these or other embodiments, one or more of the input device(s) can be similar or identical to keyboard 104 (FIG. 1) and/or a mouse 110 (FIG. 1). Further, one or more of the display device(s) can be similar or identical to monitor 106 (FIG. 1) and/or screen 108 (FIG. 1). The input device(s) and the display device(s) can be coupled to integrated indexing system 310, search system 315, and/or web server 320 in a wired manner and/or a wireless manner, and the coupling can be direct and/or indirect, as well as locally and/or remotely. As an example of an indirect manner (which may or may not also be a remote manner), a keyboard-video-mouse (KVM) switch can be used to couple the input device(s) and the display device(s) to the processor(s) and/or the memory storage unit(s). In some embodiments, the KVM switch also can be part of integrated indexing system 310, search system 315, and/or web server 320. In a similar manner, the processors and/or the non-transitory computer-readable media can be local and/or remote to each other.

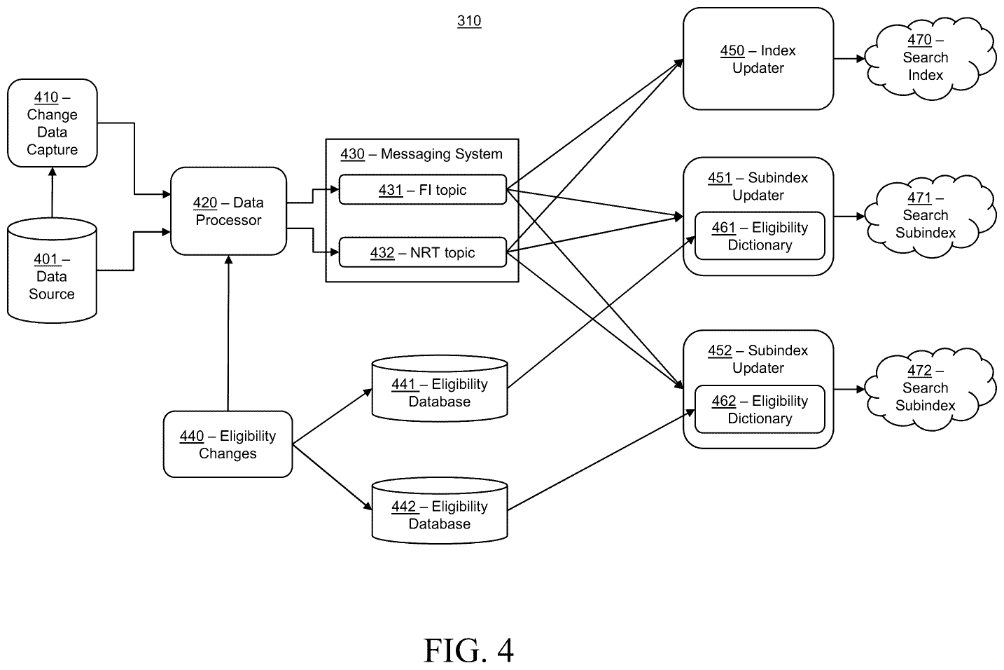

Meanwhile, in many embodiments, integrated indexing system 310, search system 315, and/or web server 320 also can be configured to communicate with one or more databases, such as the databases shown in FIG. 4 and described below. The one or more databases can include a product database that contains information about products, items, or SKUs (stock keeping units), for example, among other information, such as the search indexes and subindexes generated by integrated indexing system 310, and/or other suitable information, as described below in further detail. The one or more databases can be stored on one or more memory storage units (e.g., non-transitory computer readable media), which can be similar or identical to the one or more memory storage units (e.g., non-transitory computer readable media) described above with respect to computer system 100 (FIG. 1). Also, in some embodiments, for any particular database of the one or more databases, that particular database can be stored on a single memory storage unit or the contents of that particular database can be spread across multiple ones of the memory storage units storing the one or more databases, depending on the size of the particular database and/or the storage capacity of the memory storage units.

The one or more databases can each include a structured (e.g., indexed) collection of data and can be managed by any suitable database management systems configured to define, create, query, organize, update, and manage database(s). Exemplary database management systems can include MySQL (Structured Query Language) Database, PostgreSQL Database, Microsoft SQL Server Database, Oracle Database, SAP (Systems, Applications, & Products) Database, and IBM DB2 Database.

Meanwhile, integrated indexing system 310, web server 320, and/or the one or more databases can be implemented using any suitable manner of wired and/or wireless communication. Accordingly, system 300 can include any software and/or hardware components configured to implement the wired and/or wireless communication. Further, the wired and/or wireless communication can be implemented using any one or any combination of wired and/or wireless communication network topologies (e.g., ring, line, tree, bus, mesh, star, daisy chain, hybrid, etc.) and/or protocols (e.g., personal area network (PAN) protocol(s), local area network (LAN) protocol(s), wide area network (WAN) protocol(s), cellular network protocol(s), powerline network protocol(s), etc.). Exemplary PAN protocol(s) can include Bluetooth, Zigbee, Wireless Universal Serial Bus (USB), Z-Wave, etc.; exemplary LAN and/or WAN protocol(s) can include Institute of Electrical and Electronic Engineers (IEEE) 802.3 (also known as Ethernet), IEEE 802.11 (also known as WiFi), etc.; and exemplary wireless cellular network protocol(s) can include Global System for Mobile Communications (GSM), General Packet Radio Service (GPRS), Code Division Multiple Access (CDMA), Evolution-Data Optimized (EV-DO), Enhanced Data Rates for GSM Evolution (EDGE), Universal Mobile Telecommunications System (UMTS), Digital Enhanced Cordless Telecommunications (DECT), Digital AMPS (IS-136/Time Division Multiple Access (TDMA)), Integrated Digital Enhanced Network (iDEN), Evolved High-Speed Packet Access (HSPA+), Long-Term Evolution (LTE), WiMAX, etc. The specific communication software and/or hardware implemented can depend on the network topologies and/or protocols implemented, and vice versa. In many embodiments, exemplary communication hardware can include wired communication hardware including, for example, one or more data buses, such as, for example, universal serial bus(es), one or more networking cables, such as, for example, coaxial cable(s), optical fiber cable(s), and/or twisted pair cable(s), any other suitable data cable, etc. Further exemplary communication hardware can include wireless communication hardware including, for example, one or more radio transceivers, one or more infrared transceivers, etc. Additional exemplary communication hardware can include one or more networking components (e.g., modulator-demodulator components, gateway components, etc.).

In many embodiments, integrated indexing system 310 can include various systems. In many embodiments, the systems of integrated indexing system 310 can be modules of computing instructions (e.g., software modules) stored at non-transitory computer readable media that operate on one or more processors. In other embodiments, the systems of integrated indexing system 310 can be implemented in hardware. Integrated indexing system 310, search system 315, and/or web server 320 each can be a computer system, such as computer system 100 (FIG. 1), as described above, and can be a single computer, a single server, or a cluster or collection of computers or servers, or a cloud of computers or servers. In another embodiment, a single computer system can host integrated indexing system 310, search system 315, and/or web server 320. Additional details regarding integrated indexing system 310 and the components thereof are described herein.

In many embodiments, system 300 can provide an integrated index platform supporting subindexes. With availability of open source search software, such as Solr and Elasticsearch, many organizations now can build search systems at a manageable cost. A modern search system contains one or more search indexes. A search index contains documents in searchable form. These documents are extracted from different data sources and sent to the search system to add to the search index.

Large search systems usually use an indexing platform to index documents. An indexing platform can have two stages. First, a data extraction stage uses a data processor job (e.g., data processor 420 in FIG. 4 described below) to extract documents from one or more data sources (e.g., data source 401 in FIG. 4 described below), transform those extractions into index messages with a new format, and save those index messages to an intermediate message queue system (e.g., messaging system 430 in FIG. 4 described below), such as Kafka. The data processor job also can listen for document change events when the documents change, and can generate index messages to update downstream search indexes (e.g., search index 470 in FIG. 4 described below). Second, an index update stage can use an index updater (e.g., index updater 450 in FIG. 4 described below) to read index messages from the messaging system, transform them to a target format, and then update the target search indexes.

An indexing platform can support the various processes to refresh the search index and keep those search indexes up to date. For example, a near real time (NRT) update process can be used, in which document change events, such as adds, deletes, and updates to the documents, are captured (e.g., by change data capture 410 in FIG. 4 described below) and sent to the data processor to update the search index. As another example, a full index (FI) process can be used, in which all eligible documents are extracted from data sources to reset each search index with most recent data. In many cases, both the NRT and FI processes can be used.

If the index size is large, the FI process can take multiple hours to complete. Some documents in the data source can change during the FI process and cause the FI data to become slightly out of date. After extracting the data from the data source, the index platform can use a catchup process to reapply item changes since the start of the FI process to main index.

If high indexing performance is desired, an index platform can be scaled out horizontally with multiple message streams. Messaging system such as Kafka can have multiple message partitions in a topic. The data processor can distribute index messages to multiple message partitions. The index updater service can run on multiple computing nodes. Each index updater node can be assigned an exclusive subset of message partitions to read messages from.

A large ecommerce site usually has a large search index that contains hundreds of millions of items for customers to search. In addition to the main search capability, some use cases use only a subset of the search index. A subindex is a small subset of items in the main index. For example, in marketplace advertising, an ecommerce site may offer advertisement services for sellers to promote their items. A subindex can be beneficial to find relevant promotional items when customers search the site. As another example, it can be beneficial for an ecommerce site to build a high-performance subindex (e.g., a premier subindex) with a small number of most valuable items, for example, 1% of items from main index that covers 90% of revenue.

Using subindexes can advantageously allow a search service to improve search results. For example, an ecommerce site can obtain eligible advertisement items from an advertisement subindex's search result and integrate them with the main index's search result. If the advertisement subindex is not available, a search result from the main index may not contain any eligible items for advertisement, which can cause degradation on advertisement results.

Modern cloud-based search services allow a main index to be split into multiple shards and query data from specific shards. Each shard is a self-contained search index. An application can build a specialized main index with multiple shards on a cloud-based environment using sharding, for example, putting all items in electronics category to one shard, and others to other shards. The index updaters on the index platform can implement document routing logic based on predefined routing rules to route documents to the right shards.

Implementing sharding of indexes does not involve creating additional indexes, which can be a cost-effective solution for some applications. However, it can be difficult to add new index shards. Changing index shards involves restructuring of the main index and potentially involves restructuring of its search cluster. In addition, sharding cannot support shards whose membership cannot be determined using rules.

Applications like the advertisements subindex and the premier subindex described above are not suitable for sharding, and can instead be implemented using the novel subindex techniques described herein. Each subindex can be an independent search index and can be updated and queried independently using its own indexing platform.

Building a subindex can involve specifying eligibility criteria to determine what items are eligible to be included in the subindex. Eligibility criteria can be rule-based (e.g., all items in electronics category) or item-based (e.g., items that are registered for a promotion program).

With item-based eligibility criteria, a subindex can have a mechanism to identify the collection of eligible items. If the collection is static, it can be managed using simple mechanism, e.g., a file that contains a list of item ids. If a subindex's eligible items change frequently, a repository or database system can be used to manage them. For example, new items may be added to a subindex for a period for a promotional campaign, and existing items may expire and be removed from the subindex for the campaign.

Turning ahead in the drawings, FIG. 4 illustrates a block diagram of integrated indexing system 310 that implements an integrated index platform supporting two search subindexes, and illustrates a message flow within that platform, according to any embodiment. Integrated indexing system 310 is merely exemplary and embodiments of the system are not limited to the embodiments presented herein. The system can be employed in many different embodiments or examples not specifically depicted or described herein. In some embodiments, certain elements, modules, or systems of integrated indexing system 310 can perform various procedures, processes, and/or activities. In other embodiments, the procedures, processes, and/or activities can be performed by other suitable elements, modules, or systems of integrated indexing system 310.

Referring to FIG. 4, documents can be stored in a data source 401 of integrated indexing system 310 (and which in many cases can be external to integrated indexing system 310), and changes to those documents can be captured by a change data capture 410 of integrated indexing system 310 (or external to integrated indexing system 310). In a data extraction stage, a data processor 420 of integrated indexing system 310 can obtain (receive or pull) data from data source 401 as part of an FI process, and/or can obtain (receive or pull) data from change data capture 410 as part of an NRT process. Data processor 420 can process the documents to create index messages, and send the index messages for the FI process or the NRT process to a messaging system 430 of integrated indexing system 310 (or external to integrated indexing system 310) in a respective messaging queue, such as a FI topic 431 or a NRT topic 432, respectively. An index updater 450 of integrated indexing system 310 can read index messages from messaging system 430, transform them to updates in a target format, and send these updates to a search index 470, which can update or reset search index 470, depending on whether the updates are from an NRT process or an FI process, respectively. Search index 470 can be stored within and/or externally to integrated indexing system 310. For example, search index 470 can be stored within search system 315 (FIG. 3).

Instead of building a new index platform for each subindex, because a subindex contains merely a subset of items in main index, a more efficient approach is to extend the indexing platform for the main index (e.g., search index 470) with additional components. The data extract stage (e.g., data processor 420) and the messaging system (e.g., 430) of the indexing platform can be shared.

To support a subindex, a new subindex updater, which is an enhanced version of index updater with subindex features, can be added to the second stage, such as subindex updaters 451 and/or 452 of integrated indexing system 310. The subindex updater can be a plug-in to an index updater (e.g., 450), or a separate updater, and can support various features. For example, on processing an FI or NRT index messages for a subindex, subindex updaters 451 and/or 452 can update or delete items when they are eligible for a respective subindex, such as search subindex 471 and/or 472, respectively. Search subindexes 471 and/or 472 can be stored within and/or externally to integrated indexing system 310. For example, search subindexes 471 and/or 472 can be stored within search system 315 (FIG. 3). Subindex updaters 451 and/or 452 can each maintain an eligibility dictionary, such as eligibility dictionaries 461 and/or 462, respectively, to determine if an item is eligible for the subindex (e.g., search subindex 471 and/or 472 respectively). If a subindex (e.g., search subindex 471 and/or 472 respectively) uses item-based eligibility criteria, subindex updaters 451 and/or 452 can each maintain the respective eligibility dictionary (e.g., eligibility dictionaries 461 and/or 462, respectively) by loading data from a respective eligibility database, such as eligibility databases 441 and/or 442 of integrated indexing system 310, for fast eligibility lookups. In many embodiments, eligibility changes 440 for a respective subindex (e.g., search subindex 471 and/or 472 respectively) can be processed by subindex updaters 451 and/or 452 as subindex eligibility change events, such as add, update, and delete events to the eligibility criteria for the respective subindex (e.g., search subindex 471 and/or 472 respectively), such as new items becoming eligible, or items becoming ineligible. In many embodiments, subindex updaters 451 and/or 452 can have subindex-specific business logic. For example, an advertisement eligibility entry may contain properties that specify the period of a campaign. The search index (e.g., 471 and/or 472) can be stored a single processing node (e.g. computer, server, or virtual machine), multiple nodes, in the cloud, or in other suitable ways.

If a subindex uses rule-base eligibility criteria, its subindex updater (e.g., 451, 452) can parse the rule to determine item eligibility when processing a FI or NRT index message. The subindex updater (e.g., 451, 452) can support an API to get a notification when any rule changes and/or to reload rules from its eligibility database (e.g., 441, 442). If any rule of a subindex changes, the subindex also can complete full index refresh.

Subindexes that manage item eligibility can store eligibility entries in database tables. For example, an eligibility entry can include various information, such as the following data:
Item id—A field that uniquely identifies an item. It can be the same unique id that is used as key in the messaging system (e.g., 430) and the main index (e.g., 450).
Eligible—An optional Boolean field that indicates if the item is eligible for the subindex. In some cases, the default value can be TRUE.
Properties—An optional key-value map for subindex specific business logic.

A subindex updater (e.g., 451, 452) can process items that are eligible for a single the subindex (e.g., 471, 472, respectively). In some embodiments, if the subindex (e.g., 471, 472) is much smaller than main index (e.g., search index 470), the subindex updater can load eligibility data from the eligibility database (e.g., 441, 442) into a local eligibility dictionary (e.g., 461, 462) and use it for fast eligibility lookups. The local eligibility dictionary can function similar to a cache, but in many embodiments can be more stable (change less often) than a typical cache. The local eligibility dictionary (e.g., 461, 462) can be kept consistent with eligibility data in the eligibility database (e.g., 441, 442).

In integrated indexing system 310, search subindexes 471 and 472 are generated by sharing the same processes for FI and NRT updates used for updating the main index (e.g., search index 470). The same full index process can refresh the main index and all subindexes. NRT updates also can be applied to all subindexes. In addition to existing FI and NRT updates, subindexes also can handle changes on its eligibility data.

For subindexes with item-based eligibility, eligibility data can change in various situations, including the following situations:
An item that is currently ineligible for the subindex becomes eligible.
An item that is currently eligible for the subindex becomes ineligible.
Option field or properties of an eligible entry have changed.

Eligibility data changes could cause various issues on subindex if not properly handled, such as the following issues:
Missing NRT updates on eligibility data changes. NRT update events are triggered when main item data source has changes. Changes on subindex eligibility data do not trigger them. A subindex can become inconsistent if its eligibility changes. For example, if an item in a subindex becomes ineligible, the item will remain in the subindex.
The FI process can miss some eligibility data changes, and the post-FI catchup process does not capture eligibility data changes.
The subindex updater's local eligibility dictionary becomes inconsistent with data in eligibility database.

To address these issues, on eligibility changes 440, the eligibility database (e.g., 441, 442) can be updated first. After the eligibility database has been updated, eligibility change events can be generated and sent to data processor 420 to refresh data in the corresponding subindexes and eligibility dictionaries.

Data processor 420 can capture eligibility data changes and generate proper index update messages to refresh the subindex. An eligibility change event can include various information, such as the following fields:
Event type—A field that specifies the type of subindex eligibility change events.
Subindex id—A field that uniquely identify a subindex.
Item id—A field that uniquely identify an item. It can be the same unique id that is used as key in messaging system and main index.
Optional fields for subindex specific business logic processing.

Because a subindex is much smaller that main index, looking up information from the eligibility database (e.g., 441, 442) for every index message can be very inefficient and costly. To address this issue, a bloom filter can be used to reduce the number of database look ups. However, by its nature, it is impossible to remove items from a bloom filter without introducing false negatives on other items. If items can become eligible and ineligible later any time and multiple times, using bloom filter can be suboptimal.

In many embodiments, these performance problem on eligibility lookups can be addressed by using an item eligibility dictionary (e.g., eligibility dictionary 461, 462) in each subindex updater (e.g., 451, 452) and maintaining eligibility data consistency using eligibility change events. Each subindex updater (e.g., 451, 452) initializes its item eligibility dictionary by loading data from eligibility database when the node for the subindex updater (e.g., 451, 452) is started and/or when the node for the subindex updater (e.g., 451, 452) changes to read from different message partitions.

If the node for a subindex updater (e.g., 451, 452) for a subindex fails, other nodes can handle message partitions originally associated with the failed node. Every node of the subindex updater (e.g., 451, 452) with a new message partition assignment can reload data from the eligibility database (e.g., 441, 442) to keep the local eligibility dictionary (e.g., eligibility dictionary 461, 462) up to date. When eligibility data in the eligibility database (e.g., 441, 442) changes, it is insufficient to directly send the event to the associated subindex updater (e.g., 451, 452) to update the associated eligibility dictionary (e.g., 461, 462) because a new item may become eligible and should be added to a subindex, but the eligibility change event does not have full item data to add the item to the subindex.

When an item changes its eligibility on the subindex, an eligibility change event can be generated and sent to data processor 420. On receiving an eligibility change event, data processor 420 can perform various steps, such as the following steps:
Extract item content from data source 401 and generates an index update message. If the item has been deleted from data source, it generates an index delete message.
Add eligibility change event's fields as headers of the index message.
Ensure that the index message is not removed due to any message deduplication logic.
Write the index message to NRT topic 432 of messaging system 430.

The index message can be read from messaging system 430 by all of the index updaters (e.g., index updater 450, subindex updaters 451, 452). Each subindex updater (e.g., 451, 452) can perform various steps depending on the particular subindex to which the eligibility change event applies. For example, the subindex updater (e.g., 451, 452) can perform the following steps:
Extract message headers and determine if the index message is an eligibility change event for its subindex.
If the index message is not an eligibility change event for the particular subindex, process the message the same as for a normal index message.
If index message is an eligibility change event for the particular subindex, perform various steps, such as the following steps:
   Update the local eligibility dictionary (e.g., 461, 462) with data from eligibility database (e.g., 441, 442) for the subindex.
   If the item is eligible, add the item to the subindex (e.g., 471, 472) with data from the index message.
   If the item is not eligible or not present in eligibility dictionary, delete the item from the subindex (e.g., 471, 472).

The integrated indexing platform can allow message workflows for the main index (search index 470) and the subindexes (e.g., search subindexes 471, 472) to share a common data extract stage (e.g., data processor 420) and messaging system (messaging system 430). Index messages for the same item can use the same message partitions and be processed by the same node for the subindex updater (e.g., 471, 472). Since the node for the index updater (e.g., 471, 472) has the latest eligibility data in the eligibility dictionary (e.g., 461, 462) after processing an item's eligibility change event, all subsequent changes to the same item can be processed correctly.

Using the integrated workflow also can ensure that both eligibility change events and item content change events for same items can be processed correctly. For example, considering the following two change events:
1. An item is changed and triggers an NRT update to update main index and a subindex.
2. The same item just became ineligible for the same subindex and triggers an eligibility change event to delete the item from the subindex.

The item should be removed from the subindex regardless how these two events are processed. If these two events are routed to the same subindex updater instance for the subindex, they can be handled in one of the following two ways.
1. If the NRT change event is received first and then the eligibility change event is received: The item is updated first due to the NRT change event, and then removed due to the eligibility change event.
2. If the eligibility change event is received first and then the NRT change event is received: The item is removed from local eligibility dictionary and is removed from the subindex due to the eligibility change event. Later the NRT change event is ignored because the item is no longer eligible for the subindex.
   The item can be removed correctly from the subindex either way.

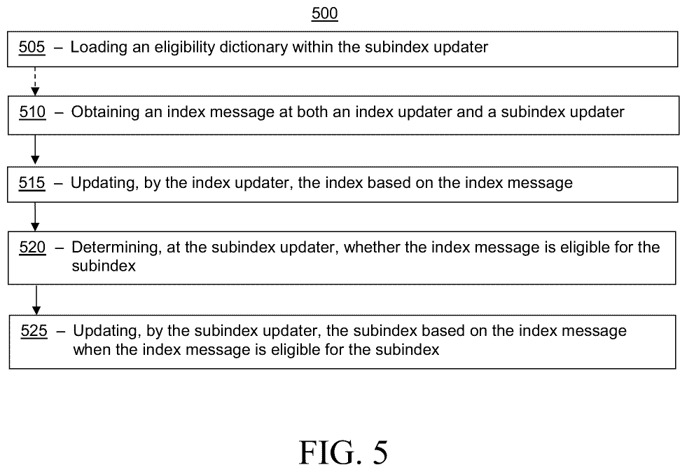

Turning ahead in the drawings, FIG. 5 illustrates a flow chart for a method 500 of providing an integrated index platform supporting subindexes, according to another embodiment. Method 500 is merely exemplary and is not limited to the embodiments presented herein. Method 500 can be employed in many different embodiments or examples not specifically depicted or described herein. In some embodiments, the procedures, the processes, and/or the activities of method 500 can be performed in the order presented. In other embodiments, the procedures, the processes, and/or the activities of method 500 can be performed in any suitable order. In still other embodiments, one or more of the procedures, the processes, and/or the activities of method 500 can be combined or skipped.

In many embodiments, system 300 (FIG. 3) and/or integrated indexing system 310 (FIG. 3) can be suitable to perform method 500 and/or one or more of the activities of method 500. In these or other embodiments, one or more of the activities of method 500 can be implemented as one or more computing instructions configured to run at one or more processors and configured to be stored at one or more non-transitory computer readable media. Such non-transitory computer readable media can be part of system 300 (FIG. 3). The processor(s) can be similar or identical to the processor(s) described above with respect to computer system 100 (FIG. 1).

In some embodiments, method 500 and other activities in method 500 can include using a distributed network including distributed memory architecture to perform the associated activity. This distributed architecture can reduce the impact on the network and system resources to reduce congestion in bottlenecks while still allowing data to be accessible from a central location.

Referring to FIG. 5, method 500 can include an activity 505 of loading an eligibility dictionary within a subindex updater from an eligibility database. The subindex updater can be similar or identical to subindex updater 451 and/or 452 (FIG. 4). The eligibility dictionary can be similar or identical to eligibility dictionary 461 and/or 462 (FIG. 4). The eligibility database can be similar or identical to eligibility database 441 and/or 442 (FIG. 4). In some embodiments, the eligibility dictionary is loaded when the subindex updater is started. In the same or other embodiments, the eligibility dictionary is loaded (or re-loaded) when the subindex updater is changed to read from a different message partition.

In a number of embodiments, method 500 also can include an activity 510 of obtaining an index message at both (a) an index updater for an index and (b) a subindex updater for a subindex. The index updater can be similar or identical to index updater 450 (FIG. 4). The index can be similar or identical to search index 470 (FIG. 4). The subindex updater can be similar or identical to subindex updater 451 and/or 452 (FIG. 4). The subindex can be similar or identical to search subindex 471 and/or 472 (FIG. 4). In many embodiments, the index message can be read from a messaging system, such as messaging system 430 (FIG. 4). In many embodiments, there can be additional subindex updaters supporting additional subindexes.

In several embodiments, method 500 additionally can include an activity 515 of updating, by the index updater, the index based on the index message. This update of the index can be done according to conventional techniques.

In a number of embodiments, method 500 further can include an activity 520 of determining, at the subindex updater, whether the index message is eligible for the subindex. In a number of embodiments, activity 520 can include determining whether the index message is eligible for the subindex based on the eligibility dictionary within the subindex updater.

In a number of embodiments, activity 520 can include determining whether the index message includes an eligibility change event for the subindex. If so, activity 520 can include updating the eligibility dictionary within the subindex updater based on the eligibility database. In many embodiments, the index message can be generated by a data processor that receives notice of the eligibility change event after the eligibility database is updated. The data processor can be similar or identical to data processor 420 (FIG. 4).

In several embodiments, method 500 additionally can include an activity 525 of updating, by the subindex updater, the subindex based on the index message when the index message is eligible for the subindex. In many embodiments, activity 525 can include, when the index message includes the eligibility change event for the subindex, determining whether an item associated with the index message is eligible in the eligibility dictionary, as updated. If the item is eligible, activity 525 can further include adding the item to the subindex based on data for the item in the index message. If the item is not eligible, activity 525 can further include deleting the item from the subindex. In many embodiments, activities 520 and/or 525 can be performed before, after, or concurrently with activity 515.

In many embodiments, the techniques described herein can provide a practical application and several technological improvements. In some embodiments, the techniques described herein can provide an integrated indexing platform to support subindexes, which in some embodiments can provide various benefits. For example, in some embodiments, the techniques described herein can use the same index message workflow to support both the main index and the subindexes. In some embodiments, the techniques described herein can use an eligibility dataset to determine item eligibility for a subindex. In some embodiments, the techniques described herein can share the main index's message workflow to publish eligible items to subindexes in a publish-subscribe messaging framework. In some embodiments, the techniques described herein can use integrated message flow to handle both item content change events and eligibility change events. In some embodiments, the techniques described herein can generate an index message for each eligibility change event with index update content, if available, and eligibility message headers to update eligibility dictionary as well as subindex. In some embodiments, the techniques described herein can improve performance on checking if items are eligible for a subindex by using an eligibility dictionary. In some embodiments, every subindex updater node can load its eligibility dictionary with data from the subindex's eligibility database when starting up. In some embodiments, the techniques described herein can maintain item eligibility dictionary with eventual consistency. Real-time updates to a subindex's eligibility dictionary can be done using eligibility change events. In some embodiments, the techniques described herein can a subindex updater can reload item the eligibility dictionary with data from the eligibility database when it is assigned different message partitions. In some embodiments, the techniques described herein can use an integrate message flow for both item content changes and item eligibility changes to ensure that change events are processed correctly by common index updater and/or subindex updater nodes.

In a number of embodiments, the techniques described herein can solve a technical problem that arises only within the realm of computer networks, as search engines with search engine indexing does not exist outside the realm of computer networks. Moreover, the techniques described herein can solve a technical problem that cannot be solved outside the context of computer networks. Specifically, the techniques described herein can generate search indexes and search subindexes that are useless outside the context of computer networks.

Various embodiments can include a system including one or more processors and one or more non-transitory computer-readable media storing computing instructions that, when executed on the one or more processors, cause the one or more processors to perform certain acts. The acts can include obtaining an index message at both (a) an index updater for an index and (b) a subindex updater for a subindex. The acts also can include updating, by the index updater, the index based on the index message. The acts additionally can include determining, at the subindex updater, whether the index message is eligible for the subindex. The acts further can include updating, by the subindex updater, the subindex based on the index message when the index message is eligible for the subindex.

A number of embodiments can include a method being implemented via execution of computing instructions configured to run at one or more processors. The method can include obtaining an index message at both (a) an index updater for an index and (b) a subindex updater for a subindex. The method also can include updating, by the index updater, the index based on the index message. The method additionally can include determining, at the subindex updater, whether the index message is eligible for the subindex. The method further can include updating, by the subindex updater, the subindex based on the index message when the index message is eligible for the subindex.

Although the methods described above are described with reference to the illustrated flowcharts, it will be appreciated that many other ways of performing the acts associated with the methods can be used. For example, the order of some operations may be changed, and some of the operations described may be optional.

In addition, the methods and system described herein can be at least partially embodied in the form of computer-implemented processes and apparatus for practicing those processes. The disclosed methods may also be at least partially embodied in the form of tangible, non-transitory machine-readable storage media encoded with computer program code. For example, the steps of the methods can be embodied in hardware, in executable instructions executed by a processor (e.g., software), or a combination of the two. The media may include, for example, RAMs, ROMs, CD-ROMs, DVD-ROMs, BD-ROMs, hard disk drives, flash memories, or any other non-transitory machine-readable storage medium. When the computer program code is loaded into and executed by a computer, the computer becomes an apparatus for practicing the method. The methods may also be at least partially embodied in the form of a computer into which computer program code is loaded or executed, such that, the computer becomes a special purpose computer for practicing the methods. When implemented on a general-purpose processor, the computer program code segments configure the processor to create specific logic circuits. The methods may alternatively be at least partially embodied in application specific integrated circuits for performing the methods.

The foregoing is provided for purposes of illustrating, explaining, and describing embodiments of these disclosures. Modifications and adaptations to these embodiments will be apparent to those skilled in the art and may be made without departing from the scope or spirit of these disclosures.

Although an integrated index platform supporting subindexes has been described with reference to specific embodiments, it will be understood by those skilled in the art that various changes may be made without departing from the spirit or scope of the disclosure. Accordingly, the disclosure of embodiments is intended to be illustrative of the scope of the disclosure and is not intended to be limiting. It is intended that the scope of the disclosure shall be limited only to the extent required by the appended claims. For example, to one of ordinary skill in the art, it will be readily apparent that any element of FIGS. 1-5 may be modified, and that the foregoing discussion of certain of these embodiments does not necessarily represent a complete description of all possible embodiments. For example, one or more of the procedures, processes, or activities of FIG. 5 and or the message flows within FIG. 4 may include different procedures, processes, and/or activities and be performed by many different modules, in many different orders, and/or can be interchanged or otherwise modified. As another example, the systems within system 300 (FIG. 3), search system 315 (FIG. 3), and/or the systems integrated indexing system 310 (as shown in FIG. 4) can be interchanged or otherwise modified.

Replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1. A system comprising:
one or more processors; and
one or more non-transitory computer-readable media storing computing instructions that, when executed on the one or more processors, cause the one or more processors to perform:
obtaining an index message at both (a) an index updater for an index and (b) a subindex updater for a subindex;
updating, by the index updater, the index based on the index message;
determining, at the subindex updater, whether the index message is eligible for the subindex; and
updating, by the subindex updater, the subindex based on the index message when the index message is eligible for the subindex.

2. The system of claim 1, wherein the computing instructions, when executed on the one or more processors, further cause the one or more processors to perform:
loading an eligibility dictionary within the subindex updater from an eligibility database.

3. The system of claim 2, wherein the eligibility dictionary is loaded when the subindex updater is started.

4. The system of claim 2, wherein the eligibility dictionary is loaded when the subindex updater is changed to read from a different message partition.

5. The system of claim 1, wherein determining whether the index message is eligible for the subindex further comprises:
determining whether the index message is eligible for the subindex based on an eligibility dictionary within the subindex updater.

6. The system of claim 1, wherein determining whether the index message is eligible for the subindex further comprises:
determining whether the index message comprises an eligibility change event for the subindex; and
updating an eligibility dictionary within the subindex updater based on an eligibility database when the index message comprises the eligibility change event for the subindex.

7. The system of claim 6, wherein the index message is generated by a data processor that receives notice of the eligibility change event after the eligibility database is updated:

8. The system of claim 6, wherein updating the subindex further comprises:
determining whether an item associated with the index message is eligible in the eligibility dictionary, as updated, when the index message comprises the eligibility change event for the subindex.

9. The system of claim 8, wherein updating the subindex further comprises:
adding the item to the subindex based on data for the item in the index message when the item is eligible.

10. The system of claim 8, wherein, updating the subindex further comprises:
deleting the item from the subindex when the item is not eligible.

11. A method implemented via execution of computing instructions configured to run at one or more processors, the method comprising:
obtaining an index message at both (a) an index updater for an index and (b) a subindex updater for a subindex;
updating, by the index updater, the index based on the index message;
determining, at the subindex updater, whether the index message is eligible for the subindex; and
updating, by the subindex updater, the subindex based on the index message when the index message is eligible for the subindex.

12. The method of claim 11 further comprising:
loading an eligibility dictionary within the subindex updater from an eligibility database.

13. The method of claim 12, wherein the eligibility dictionary is loaded when the subindex updater is started.

14. The method of claim 12, wherein the eligibility dictionary is loaded when the subindex updater is changed to read from a different message partition.

15. The method of claim 11, wherein determining whether the index message is eligible for the subindex further comprises:
determining whether the index message is eligible for the subindex based on an eligibility dictionary within the subindex updater.

16. The method of claim 11, wherein determining whether the index message is eligible for the subindex further comprises:
determining whether the index message comprises an eligibility change event for the subindex; and
updating an eligibility dictionary within the subindex updater based on an eligibility database when the index message comprises the eligibility change event for the subindex.

17. The method of claim 16, wherein the index message is generated by a data processor that receives notice of the eligibility change event after the eligibility database is updated:

18. The method of claim 16, wherein updating the subindex further comprises:
determining whether an item associated with the index message is eligible in the eligibility dictionary, as updated, when the index message comprises the eligibility change event for the subindex.

19. The method of claim 18, wherein updating the subindex further comprises:
adding the item to the subindex based on data for the item in the index message when the item is eligible.

20. The method of claim 18, wherein, updating the subindex further comprises:
deleting the item from the subindex when the item is not eligible.
